(19) United States
(12) Patent Application Publication
(10) Pub. No.: US 2014/0213724 A1
(43) Pub. Date: Jul. 31, 2014

(54) POLYIMIDE PRECURSOR COMPOSITION AND METHOD FOR PRODUCING POLYIMIDE PRECURSOR COMPOSITION

(71) Applicant: Fuji Xerox Co., Ltd., Tokyo (JP)

(72) Inventors: Tsuyoshi MIYAMOTO, Kanagawa (JP); Kana MIYAZAKI, Kanagawa (JP); Katsumi NUKADA, Kanagawa (JP)

(73) Assignee: FUJI XEROX CO., LTD., Tokyo (JP)

(21) Appl. No.: 14/038,230

(22) Filed: Sep. 26, 2013

(30) Foreign Application Priority Data
Jan. 31, 2013 (JP) 2013-017934

(51) Int. Cl. C08L 79/08

(52) U.S. Cl. CPC C08L 79/08
USPC 524/845

(57) ABSTRACT

A polyimide precursor composition includes: a resin that contains a repeating unit represented by the following Formula (I) and has an imidization rate of 0.2 or less,

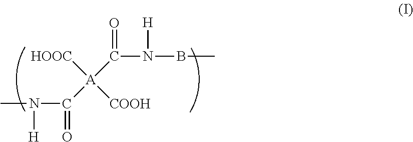

wherein A represents a tetravalent organic group, and B represents a divalent organic group; an aliphatic cyclic amine compound; and an aqueous solvent, wherein the resin and the aliphatic cyclic amine compound are dissolved in the aqueous solvent.

### CROSS-REFERENCE TO RELATED APPLICATIONS

This application is based on and claims priority under 35 USC 119 from Japanese Patent Application No. 2013-017934 filed Jan. 31, 2013.

### BACKGROUND

1. Technical Field

The present invention relates to a polyimide precursor composition and a method for producing a polyimide precursor composition.

2. Related Art

A polyimide resin is a material having characteristics of being excellent in high durability and thermal resistance, and is widely used for electronic materials.

### SUMMARY

According to an aspect of the invention, there is provided a polyimide precursor composition including:

a resin that contains a repeating unit represented by the following Formula (I) and has an imidization rate of 0.2 or less,

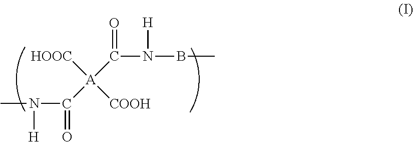

wherein A represents a tetravalent organic group, and B represents a divalent organic group;

an aliphatic cyclic amine compound; and

an aqueous solvent,

wherein the resin and the aliphatic cyclic amine compound are dissolved in the aqueous solvent.

### DETAILED DESCRIPTION

Hereinafter, the exemplary embodiments of the present invention will be described in detail.

Polyimide Precursor Composition

The polyimide precursor composition according to the present exemplary embodiment is a composition in which an aliphatic cyclic amine compound and a resin (hereinafter, described as a “specific polyimide precursor”) which contains a repeating unit represented by Formula (I) and has an imidization rate of 0.2 or less have dissolved in an aqueous solvent. That is, the specific polyimide precursor and the aliphatic cyclic amine compound are contained in the composition in a state of being dissolved in the aqueous solvent. Moreover, the term “dissolved” means a state where a residue of the dissolved substance is not visually confirmed.

The polyimide precursor composition according to the present exemplary embodiment uses an aqueous solvent as a solvent. Herein, the aqueous solvent refers to a solvent containing at least 70% by weight or more of water.

In the exemplary embodiment, environmental suitability is excellent since the aqueous solvent is used. Moreover, when a polyimide-molded article is formed of the polyimide precursor composition, the heating temperature and heating time for distillation of the solvent may be reduced and shortened.

In the polyimide precursor composition according to the exemplary embodiment, an aliphatic cyclic amine compound has dissolved. Accordingly, the specific polyimide precursor (a carboxyl group thereof) is in a state of being made into an amine salt by the aliphatic cyclic amine compound. Therefore, solubility thereof in an aqueous solvent increases, and film forming property thereof becomes excellent.

In addition, when a polyimide-molded article is formed of the polyimide precursor composition, the aliphatic cyclic amine compound exerts an excellent imidization accelerating effect. Consequently, a polyimide resin-molded article, which is excellent in mechanical strength and various properties such as thermal resistance, electrical characteristics, and solvent resistance, is obtained. Moreover, by the imidization accelerating effect, productivity is also improved.

Furthermore, the aliphatic cyclic amine compound has dissolved in the solvent in a state of being made into an amine salt of the specific polyimide precursor (a carboxyl group thereof). Therefore, the odor unique to the amine compound is suppressed.

Moreover, the polyimide precursor composition shows a small degree of change in viscosity over a long time, and coating process may be stably performed.

In addition, if the polyimide precursor composition according to the present exemplary embodiment in which the specific polyimide precursor and the aliphatic cyclic amine compound have dissolved in an aqueous solvent is used, corrosion of a substrate to be a base is prevented when a polyimide-molded article is formed. It is considered that this is because acidity of a carboxyl group of the specific polyimide precursor is suppressed by basicity of the coexisting aliphatic cyclic amine compound.

Particularly, when the specific polyimide precursor (that is, a aromatic polyimide precursor) represented by Formula (I) in which A represents a tetravalent aromatic organic group and B represents a divalent aromatic organic group is used, the polyimide precursor generally tends not to easily dissolve in a solvent. However, in the exemplary embodiment, an aqueous solvent is used as a solvent, and the specific polyimide precursor dissolves in the solvent, in a state of being made into an amine salt by the aliphatic cyclic amine compound. Accordingly, even when the aromatic polyimide precursor is used as the specific polyimide precursor, film forming property becomes high, and environmental suitability becomes excellent.

The polyimide precursor composition according to the exemplary embodiment uses an aqueous solvent as a solvent as described above. However, the aqueous solvent preferably does not contain a non-protonic polar solvent.

The non-protonic polar solvent refers to a solvent having a boiling point of 150° C. to 300° C. and a dipole moment of 3.0 D to 5.0 D. Specific examples of the non-protonic polar solvent include N-methyl-2-pyrrolidone (NMP), N,N-dimethylformamide (DMF), N,N-dimethylacetamide (DMAc), dimethylsulfoxide (DMSO), hexamethylenephosphoramide (HMPA), N-methylcaprolactam, N-acetyl-2-pyrrolidone, and the like.

The non-protonic polar solvent represented by N-methyl-2-pyrrolidone (NMP) has a high boiling point which is 150° C. or higher, and this solvent in the composition remains in a molded article in many cases even after a drying process in the preparation of a polyimide-molded article. If the non-protonic polar solvent remains in the polyimide-molded article, reorientation of a polymer chain of the polyimide precursor occurs, and packing properties of the polymer chain deteriorate. Accordingly, mechanical strength of the obtained polyimide-molded article decreases in some cases.

On the other hand, in the polyimide precursor composition according to the exemplary embodiment, the non-protonic polar solvent is not contained in the aqueous solvent. Accordingly, the obtained polyimide-molded article does not contain the non-protonic polar solvent as well. As a result, decrease in the mechanical strength of the polyimide-molded article that is formed of the polyimide precursor composition according to the exemplary embodiment is suppressed.

The specific polyimide precursor as a polyimide precursor is not a low-molecular weight compound, does not have a structure that has increased the solubility thereof in a solvent by introducing a flexural chain, a aliphatic cyclic structure, or the like into the primary structure to reduce the force of interaction between polymer chains. The specific polyimide precursor (a carboxyl group thereof) uses an aqueous solvent as a solvent and has dissolved in the solvent by being made into an amine salt by the aliphatic cyclic amine compound. Accordingly, decrease in the mechanical strength of the polyimide-molded article that is caused by the conventional method for improving solubility of a polyimide precursor resin when the molecular weight of the polyimide precursor is reduced or the molecular structure is changed does not occur. Moreover, it is possible to dissolve the polyimide precursor in water.

In addition, a polyimide resin-molded article that is excellent in various properties such as thermal resistance, electrical characteristics, and solvent resistance as well as mechanical strength is easily obtained.

Hereinafter, the respective components of the polyimide precursor composition according to the present exemplary embodiment will be described.

Specific Polyimide Precursor

The specific polyimide precursor is a resin (polyamic acid) which contains a repeating unit represented by Formula (I) and has an imidization rate of 0.2 or less.

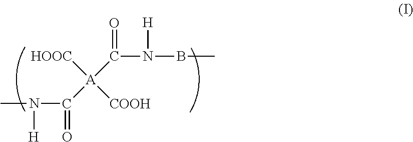

In Formula (I), A represents a tetravalent organic group, and B represents a divalent organic group.

In Formula (I), the tetravalent organic group represented by A is a residue remaining after four carboxyl groups are removed from a tetracarboxylic dianhydride as a raw material.

Meanwhile, the divalent organic group represented by B is a residue remaining after two amino groups are removed from a diamine compound as a raw material.

That is, the specific polyimide precursor containing the repeating unit represented by Formula (I) is a polymer of a tetracarboxylic dianhydride and a diamine compound.

Examples of the tetracarboxylic dianhydride include all aromatic and aliphatic compounds, and among these, aromatic compounds are preferable. That is, in Formula (I), the tetravalent organic group represented by A is preferably an aromatic organic group.

Examples of the aromatic tetracarboxylic acid include pyromellitic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenylether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2, 3, 3′,4′-biphenyltetracarboxylic dianhydride, bis(phthalic acid) phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylmethane dianhydride, and the like.

Examples of the aliphatic tetracarboxylic dianhydride include aliphatic or alicyclic tetracarboxylic dianhydrides such as butane tetracarboxylic dianhydride, 1,2,3,4-cyclobutane tetracarboxylic dianhydride, 1,3-dimethyl-1,2,3,4-cyclobutane tetracarboxylic acid, 1,2,3,4-cyclopentane tetracarboxylic dianhydride, 2,3,5-tricarboxycyclopentyl acetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-dicarboxylic dianhydride, and bicyclo[2,2,2]-oct-7-ene-2,3,5,6-tetracarboxylic dianhydride; aliphatic tetracarboxylic dianhydrides having an aromatic ring, such as 1,3,3a,4,5,9b-(hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione; and the like.

Among these, aromatic tetracarboxylic dianhydrides are preferable as the tetracarboxylic dianhydride. Specifically, for example, pyromellitic dianhydride, 3,3′,4,4′-biphenyltetracarboxylic dianhydride, 2, 3, 3′,4′-biphenyltetracarboxylic dianhydride, 3,3′,4,4′-biphenylether tetracarboxylic dianhydride, and 3,3′,4,4′-benzophenone tetracarboxylic dianhydride are preferable, pyromellitic dianhydride, 3,3′,4,4′-biphenyltetracarboxylic dianhydride, and 3,3′,4,4′-benzophenone tetracarboxylic dianhydride are more preferable, and 3,3′,4,4′-biphenyltetracarboxylic dianhydride is particularly preferable.

One kind of the tetracarboxylic dianhydride may be used alone, or two or more kinds thereof may be concurrently used in combination.

Moreover, when two or more kinds thereof are concurrently used in combination, the aromatic tetracarboxylic acids or the aliphatic tetracarboxylic acids may be concurrently used respectively, or the aromatic tetracarboxylic acid may be combined with the aliphatic tetracarboxylic acid.

Meanwhile, the diamine compound is a diamine compound having two amino groups in the molecular structure. Examples of the diamine compound include all aromatic and aliphatic compounds, and among these, aromatic compounds are preferable. That is, in Formula (I), the divalent organic group represented by B is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring and hetero atoms other than nitrogen atoms of the amino groups such as diaminotetraphenyl thiophene; aliphatic and alicyclic diamines such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylene dimethylenediamine, tricyclo[6,2,1,0^{2.7}]-undecylene dimethyldiamine, and 4,4′-methylenebis(cyclohexylamine); and the like.

Among these, aromatic diamine compounds are preferable as the diamine compound. Specifically, for example, p-phenylenediamine, m-pheylenediamine, 4,4′-diaminodiphenylmethane, 4,4′-diaminodiphenylether, 3,4′-diaminodiphenylether, 4,4′-diaminodiphenylsulfide, and 4,4′-diaminodiphenylsulfone are preferable, and 4,4′-diaminodiphenylether and p-phenylenediamine are particularly preferable.

One kind of the diamine compound may be used alone, or two or more kinds thereof may be concurrently used in combination. Moreover, when two or more kinds thereof are concurrently used in combination, the aromatic diamine compounds or the aliphatic diamine compounds may be concurrently used respectively, or the aromatic diamine compound may be combined with the aliphatic diamine compound.

The specific polyimide precursor is a resin having an imidization rate of 0.2 or less. That is, the specific polyimide precursor may be a partially imidized resin.

Specific examples of the specific polyimide precursor include resins containing the repeating units represented by Formulae (I-1), (I-2), and (I-3).

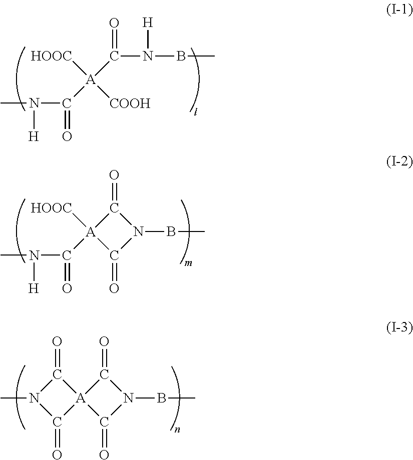

In Formulae (I-1), (I-2), and (I-3), A represents a tetravalent organic group, and B represents a divalent organic group. Moreover, A and B have the same definition as that of A and B in Formula (I).

l represents an integer of 1 or greater, and each of m and n independently represents 0 or an integer of 1 or greater and satisfies the relationship of (2n+m)/(21+2 m+2n)≦0.2.

In Formulae (I-1) to (1-3), l represents an integer of 1 or greater, preferably represents an integer of 1 to 200, and more preferably represents an integer of 1 to 100. Each of m and n independently represents 0 or an integer of 1 or greater, preferably represents 0 or an integer of 1 to 200, and more preferably represents 0 or an integer of 1 to 100.

In addition, l, m, and n satisfy the relationship of (2n+m)/(21+2 m+2n)≦0.2, preferably satisfy the relationship of (2n+m)/(21+2 m+2n)≦0.15, and more preferably satisfy the relationship of (2n+m)/(21+2 m+2n)≦0.10.

Herein, “(2n+m)/(21+2 m+2n)” indicates a ratio of the number of binding portions (2n+m) showing imide ring closure to the total number of binding portions (21+2m 2n) in binding portions (portions where the tetracarboxylic dianhydride reacts with the diamine compound) of the specific polyimide precursor. That is, “(2n+m)/(21+2 m+2n)” indicates an imidization rate of the specific polyimide precursor.

If the imidization rate (value of “(2n+m)/(21+2m+2n)”) of the specific polyimide precursor is controlled to be 0.2 or less (preferably 0.15 or less and more preferably 0.10 or less), the specific polyimide precursor is prevented from being gelated or separated by precipitation.

The imidization rate (value of “(2n+m)/(21+2m+2n)”) of the specific polyimide precursor is measured by the following method.

Measurement of Imidization Rate of Polyimide Precursor

### Preparation of Polyimide Precursor Sample

(i) The polyimide precursor composition to be measured is coated onto a silicone wafer in a film thickness ranging from 1 μm to 10 μm to prepare a coating film sample.

(ii) The coating film sample is dipped in tetrahydrofuran (THF) for 20 minutes to replace the solvent in the coating film sample with tetrahydrofuran (THF). The solvent for dipping is not limited to THF and may be selected from solvents that do not dissolve the polyimide precursor and may be miscible in a solvent component contained in the polyimide precursor composition. Specifically, alcohol solvents such as methanol and ethanol and ether compounds such as dioxane are usable.

(iii) The coating film sample is taken out of THF, and N₂ gas is blown to THF on the surface of the coating film sample to remove THF. The coating film sample is dried by being treated for 12 hours or longer within a range of 5° C. to 25° C. under a pressure reduced to 10 mmHg or less, thereby preparing a polyimide precursor sample.

### Preparation of 100% Imidized Standard Sample

(iv) The polyimide precursor composition to be measured is coated onto a silicone wafer in the same manner as in the section (i) to prepare a coating film sample.

(v) The coating film sample is subjected to an imidization reaction by being heated for 60 minutes at 380° C., thereby preparing a 100% imidized standard sample.

Measurement and Analysis

(vi) By using a Fourier transform infrared spectrophotometer (FT-730 manufactured by HORIBA, Ltd.), the infrared absorption spectra of the 100% imidized standard sample and the polyimide precursor sample are measured. The 100% imidized standard sample is measured to determine a ratio I′(100) of an absorption peak (Ab′(1780 cm⁻¹)) derived from an imide bond around 1780 cm⁻¹ to an absorption peak (Ab′(1500 cm⁻¹)) derived from an aromatic ring around 1500 cm⁻¹.

(vii) Likewise, the polyimide precursor sample is measured to determine a ratio I(x) of an absorption peak (Ab(1780 cm⁻¹)) derived from an imide bond around 1780 cm⁻¹ to an absorption peak (Ab(1500 cm⁻¹)) derived from an aromatic ring around 1500 cm⁻¹.

In addition, by using the measured absorption peaks I′(100) and I(x) respectively, an imidization rate of the polyimide precursor is calculated based on the following formula.

Formula: imidization rate of polyimide precursor=I(x)/I′(100)

Formula: I′(100)=(Ab′ (1780 cm⁻¹))/(Ab′(1500 cm⁻¹))

Formula: I(x)=(Ab(1780 cm⁻¹))/(Ab(1500 cm⁻¹))

This measurement of an imidization rate of the polyimide precursor is applied to the measurement of an imidization rate of an aromatic polyimide precursor. For measuring the imidization rate of an aliphatic polyimide precursor, instead of the absorption peak of an aromatic ring, a peak derived from a structure that does not change before and after the imidization reaction is used as an internal standard peak.

Terminal Amino Group of Polyimide Precursor

The specific polyimide precursor preferably includes a polyimide precursor (resin) having an amino group on the terminal thereof, and preferably is a polyimide precursor having amino groups on all terminals thereof.

For example, if the diamine compound used for the polymerization reaction is added in a molar equivalent that is higher than a molar equivalent of the tetracarboxylic dianhydride during the polymerization reaction, amino groups are provided to both molecular terminals of the polyimide precursor. The molar equivalent ratio between the diamine compound and the tetracarboxylic dianhydride is preferably within a range of 1.0001 to 1.2 and more preferably within a range of 1.001 to 1.2, based on 1 molar equivalent of the tetracarboxylic acid.

If the molar equivalent ratio between a diamine compound and the tetracarboxylic dianhydride is 1.0001 or higher, amino groups on the molecular terminal exert a great effect, and excellent dispersibility is obtained. If the molar equivalent ratio is 1.2 or less, the molecular weight of the obtained polyimide precursor becomes high, and for example, a sufficient film strength (tear strength and tensile strength) is easily obtained when a film-like polyimide-molded article is formed.

The terminal amino groups of the specific polyimide precursor are detected by causing a trifluoroacetic anhydride (quantitatively reacting with the amino group) to act on the polyimide precursor composition. That is, the terminal amino groups of the specific polyimide precursor are amidated by the trifluoroacetic acid. After being treated, the specific polyimide precursor is purified by reprecipitation or the like to remove the surplus trifluoroacetic anhydride and trifluoroacetic acid residue. The amount of the treated specific polyimide precursor is determined by a Nuclear Magnetic Resonance (NMR) method, whereby the amount of the terminal amino groups of the specific polyimide precursor is measured.

The number average molecular weight of the specific polyimide precursor is preferably from 1,000 to 100,000, more preferable from 5,000 to 50,000, and still more preferably from 10,000 to 30,000.

If the number average molecular weight of the specific polyimide precursor is within the above range, decrease in solubility of the specific polyimide precursor in a solvent is suppressed, and film forming property is easily secured. Particularly, when the specific polyimide precursor including a resin having amino groups on the terminal thereof is used, as the molecular weight decreases, the terminal amino groups are present in a higher proportion. Accordingly, the solubility easily decreases due to the influence of the aliphatic cyclic amine compound which also exists in the polyimide precursor composition. However, if the number average molecular weight of the specific polyimide precursor is within the above range, decrease in the solubility may be suppressed.

Moreover, if the molar equivalent ratio between the tetracarboxylic dianhydride and the diamine compound is adjusted, the specific polyimide precursor having a target number average molecular weight is obtained.

The number average molecular weight of the specific polyimide precursor is measured by Gel Permeation Chromatography (GPC) under the following measurement conditions.

Column: Tosoh TSKgelα-M (7.8 mm I.D×30 cm)

Eluent: dimethylformamide (DMF)/30 mM LiBr/60 mM phosphoric acid

Flow rate: 0.6 mL/min

Injection amount: 60 μL

Detector: RI (differential refractive index detector)

The content (concentration) of the specific polyimide precursor is preferably from 0.1% by weight to 40% by weight, more preferably from 0.5% by weight to 25% by weight, and still more preferably from 1% by weight to 20% by weight, based on the entire polyimide precursor composition.

Aliphatic Cyclic Amine Compound

The aliphatic cyclic amine compound is a compound that increases solubility of the specific polyimide precursor (a carboxyl group thereof) in an aqueous solvent by making the precursor into an amine salt and functions as an imidization accelerator as well.

Moreover, the aliphatic cyclic amine compound may preferably be a water-soluble compound. Herein, the term “water-soluble” means that a certain substance dissolves in an amount of 1% by weight or more in water at 25° C.

Examples of the aliphatic cyclic amine compound include secondary and tertiary amine compounds.

Among these, the aliphatic cyclic amine compound is preferably a tertiary amine compound. If the tertiary amine compound is used as the aliphatic cyclic amine compound, solubility of the specific polyimide precursor in an aqueous solvent easily increases, and the film forming property is easily improved.

Examples of the aliphatic cyclic amine compound include monovalent amine compounds and polyvalent amine compounds having a valency of 2 or higher. If a polyvalent amine compound having a valency of 2 or higher is used, a pseudo-crosslinked structure is easily formed between molecules of the specific polyimide precursor. Accordingly, viscosity of the polyimide composition increases, and film forming property is easily improved, even when the specific polyimide precursor has a low molecular weight.

Examples of the aliphatic cyclic amine compound include piperidines, piperazines, morpholines, pyrrolidines, pyrazolidines, and the like.

Among these, piperidines represented by the following Formula (1), piperazines represented by the following Formula (2), morpholines represented by the following Formula (3), pyrrolidines represented by the following Formula (4), and pyrazolidines represented by the following Formula (5) are preferable.

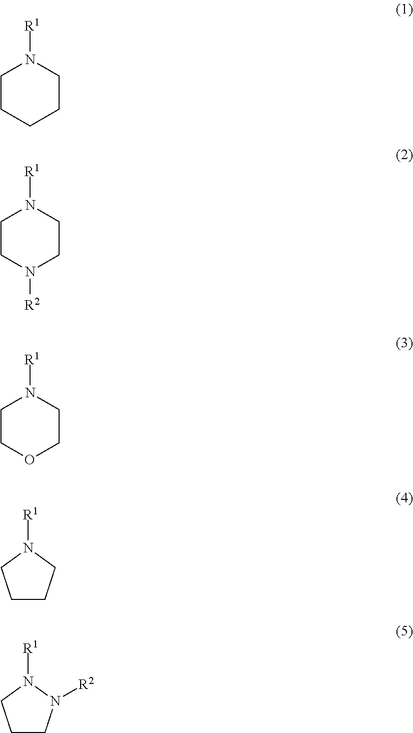

In the above Formulae (1) to (5), each of R¹ and R² independently represents a hydrogen atom, an alkyl group having 1 to 6 carbon atoms, or a phenyl group.

In addition, R¹ and R² may preferably be a hydrogen atom, a methyl group, an ethyl group, a propyl group, a butyl group, a pentyl group, a hexyl group, or a phenyl group.

Among these, morpholines are more preferable as the aliphatic cyclic amine compound, and morpholine, methyl morpholine, or ethyl morpholine is still more preferable.

In addition, the aliphatic cyclic amine compound is more preferably a compound having a boiling point of 60° C. or higher (more preferably from 60° C. to 200° C. and still more preferably from 70° C. to 150° C.). If the boiling point of the aliphatic cyclic amine compound is 60° C. or higher, the aliphatic cyclic amine compound is prevented from volatilizing from the polyimide precursor composition during storage, and decrease in the solubility of the specific polyimide precursor in an aqueous solvent is easily suppressed.

The content of the aliphatic cyclic amine compound is preferably from 50 mol % to 500 mol %, more preferably from 80 mol % to 400 mol %, and still more preferably from 100 mol % to 300 mol %, based on a carboxyl group contained in the specific polyimide precursor.

If the content of the aliphatic cyclic amine compound is within the above range, solubility of the specific polyimide precursor in an aqueous solvent easily increases, and the film forming property is easily improved. Particularly, if the content is larger than the equivalent amount with respect to the carboxyl group, excellent solution stability is obtained.

Aqueous Solvent

The aqueous solvent in the present exemplary embodiment is a solvent which contains at least 70% by weight or more of water. Examples of water include distilled water, deionized water, ultra-filtered water, pure water, and the like.

The content of water in the aqueous solvent is from 70% by weight to 100% by weight, preferably from 80% by weight to 100% by weight, and more preferably from 90% by weight to 100% by weight. The aqueous solvent particularly preferably does not contain a solvent other than water.

When a solvent other than water is used as the aqueous solvent, for example, a water-soluble organic solvent is preferably used.

Examples of the water-soluble organic solvent include a water-soluble ether solvent, water-soluble ketone solvent, and a water-soluble alcohol solvent. Herein, the term “water-soluble” means that a certain substance dissolves in an amount of 1% by weight or more in water at 25° C.

One kind of the water-soluble organic solvent may be used alone. However, when two or more kinds thereof are concurrently used, examples of the combination thereof include a combination of a water-soluble ether solvent and a water-soluble alcohol solvent, a combination of a water-soluble ketone solvent and a water-soluble alcohol solvent, and a combination of a water-soluble ether solvent, a water-soluble ketone solvent, and a water-soluble alcohol solvent.

The water-soluble ether solvent is a water-soluble solvent having an ether bond in a molecule. Examples of the water-soluble ether solvent include tetrahydrofuran (THF), dioxane, trioxane, 1,2-dimethoxyethane, diethylene glycol dimethyl ether, diethylene glycol diethyl ether, and the like. Among these, tetrahydrofuran and dioxane are preferable as the water-soluble ether solvent.

The water-soluble ketone solvent is a water-soluble solvent having a ketone group in a molecule. Examples of the water-soluble ketone solvent include acetone, methyl ethyl ketone, cyclohexanone, and the like. Among these, acetone is preferable as the water-soluble ketone solvent.

The water-soluble alcohol solvent is a water-soluble solvent having an alcoholic hydroxyl group in a molecule. Examples of the water-soluble alcohol solvent include methanol, ethanol, 1-propanol, 2-propanol, tert-butyl alcohol, ethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, 1,2,6-hexanetriol, and the like. Among these, methanol, ethanol, 2-propanol, and ethylene glycol are preferable as the water-soluble alcohol solvent.

When a solvent other than water is contained as a aqueous solvent, a boiling point of the concurrently used solvent is preferably from 160° C. or lower, more preferably from 40° C. to 150° C., and still more preferably from 50° C. to 120° C. If the boiling point of the concurrently used solvent is within this range, the solvent does not easily remain in a polyimide-molded article, and a polyimide-molded article having a high mechanical strength is easily obtained.

Other Additives

The polyimide precursor composition according to the present exemplary embodiment may contain various fillers and the like, so as to impart conductivity or various functions such as a mechanical strength to the polyimide-molded article that is prepared using the composition. The polyimide precursor composition may also contain a catalyst for accelerating the imidization reaction, a leveling material for improving quality of the prepared film, and the like.

Examples of the conductive material added for imparting conductivity include conductive materials (having a volume resistivity of, for example, less than 10⁷ Ω.cm, the same shall be applied hereinafter) and semi-conductive materials (having a volume resistivity of, for example, 10⁷ Ω.cm to 10¹³ Ω.cm, the same shall be applied hereinafter), and the material is selected according to the purpose of use.

Examples of conductive agents include carbon black (for example, acidic carbon black having pH of 5.0 or less), metals (for example, aluminum and nickel), metal oxides (for example, yttrium oxide and tin oxide), ion conductive substances (for example, potassium titanate and LiCl), conductive polymers (for example, polyaniline, polypyrrole, polysulfone, and polyacetylene), and the like.

One kind of these conductive materials may be used alone, or two or more kinds thereof may be used concurrently.

Moreover, when the conductive material has a particle form, the primary particle size thereof is preferably less than 10 μm, and more preferably 1 μm or less.

Examples of the filler added for enhancing the mechanical strength include materials having a particle form, such as silica powder, alumina powder, barium sulfate powder, titanium oxide powder, mica, and talc. In addition, in order to improve water repellency or releasability of the surface of a polyimide-molded article, fluorine resin powder such as polytetrafluoroethylene (PTFE) and a tetrafluoroethylene-perfluoroalkyl vinyl ether copolymer (PFA), and the like may be added.

As the catalyst for accelerating the imidization reaction, a dehydrating agent such as acid anhydride, an acid catalyst such as a phenol derivative, a sulfonic acid derivative, and a benzoic acid derivative, and the like may be used.

In order to improve the quality of the film prepared using the polyimide-molded article, a surfactant may be added. As the surfactant to be used, any of cationic, anionic, and nonionic surfactants may be used.

The content of other additives may be selected according to the purpose of use of the polyimide-molded article to be prepared.

Method for Producing Polyimide Precursor Composition

The polyimide precursor composition according to the present exemplary embodiment is not particularly limited. The composition is easily obtained by a preparation method in which a resin (hereinafter, described as a “polyimide precursor”) is formed by polymerizing a tetracarboxylic dianhydride and a diamine compound in an aqueous solvent in the presence of an aliphatic cyclic amine compound.

In the method for producing a polyimide precursor composition according to the present exemplary embodiment, a polyimide precursor is formed in an aqueous solvent, which does not contain a non-protonic polar solvent or contains a non-protonic polar solvent in at least a reduced amount, in the presence of an aliphatic cyclic amine compound.

In the method for producing a polyimide precursor composition according to the present exemplary embodiment, the aqueous solvent does not uses a non-protonic polar solvent causing decrease in mechanical strength of a polyimide-molded article or uses the non-protonic polar solvent in a reduced amount, and an aliphatic cyclic amine compound is added. Accordingly, hindrance in formation of the polyimide precursor (hindrance in the polymerization reaction) by the aliphatic cyclic amine compound is suppressed.

Consequently, by the method for producing a polyimide precursor composition according to the exemplary embodiment, a polyimide precursor composition from which a polyimide-molded article having a high mechanical strength is obtained is prepared.

In addition, by the method for producing a polyimide precursor composition according to the exemplary embodiment, a polyimide precursor composition from which a polyimide-molded article excellent in various properties such as thermal resistance, electrical characteristics, and solvent resistance in addition to the mechanical strength is easily obtained is produced.

Moreover, in the method for producing a polyimide precursor composition according to the present exemplary embodiment, an aqueous solvent is used as a solvent. Therefore, a polyimide precursor composition is prepared with high productivity.

The reaction temperature during the polymerization reaction of the polyimide precursor is, for example, preferably from 0° C. to 70° C., more preferably from 10° C. to 60° C., and still more preferably from 20° C. to 55° C. If the reaction temperature is controlled to be 0° C. or higher, the progress of the polymerization reaction is accelerated. Accordingly, the time taken for the reaction is shortened, and the productivity is easily improved. On the other hand, if the reaction temperature is controlled to be 70° C. or less, the progress of the imidization reaction caused in the molecule of the formed polyimide precursor is prevented. Accordingly, precipitation or gelation caused by the decrease in the solubility of the polyimide precursor is easily suppressed.

In addition, the time of the polymerization reaction of the polyimide precursor is preferably within a range of 1 hour to 24 hours according to the reaction temperature.

Example of Use of Polyimide Precursor Composition

The polyimide precursor composition according to the present exemplary embodiment is used as a coating liquid for forming a polyimide-molded article. Examples of the coating liquid for forming a polyimide-molded article include a coating liquid for forming a polyimide film, a coating liquid for forming a polyimide coat, and the like.

Examples of the polyimide film as a polyimide-molded article include flexible electronic substrate films, copper-clad laminate films, laminate films, electrical insulation films, porous films for fuel cells, separation films, and the like.

The polyimide coat as a polyimide-molded article includes an insulation coat, a thermostable coat, an IC package, adhesive films, a liquid crystal alignment film, resist films, planarizing films, microlens array films, wire cover films, optical fiber cover films, and the like.

Examples of other polyimide-molded articles include belt members, and examples of belt members include a driving belt, belts for electrophotographic image forming apparatuses (for example, an intermediate transfer belt, a transfer belt, a fixing belt, and a transport belt), and the like.

Method for Producing Polyimide-Molded Article

The polyimide precursor composition according to the present exemplary embodiment is coated onto an object to be coated, and the coating film formed in this manner is subjected to heating treatment, thereby obtaining a polyimide-molded article.

The polyimide-molded article prepared using the polyimide precursor composition is not particularly limited. Hereinafter, as an example of a method for producing a polyimide-molded article by using the polyimide precursor composition according to the present exemplary embodiment, a method for preparing an endless belt will be described in detail.

The method for producing a polyimide-molded article by using the polyimide precursor composition according to the present exemplary embodiment includes a step of forming a coating film by coating the polyimide precursor composition according to the present exemplary embodiment on an object to be coated, a step of forming an endless belt by performing heating treatment on the coating film formed on the object to be coated, and a step of detaching the endless belt from the objected to be coated.

First, the polyimide precursor composition according to the present exemplary embodiment is coated onto the inner or outer surface of a mold. As the mold, for example, a cylindrical metal mold is preferably used. Instead of the metal mold, molding tools made of other materials such as a resin, glass, and ceramic may be used. Moreover, the surface of the molding tool may be coated with glass or ceramic, or a release agent based on silicone or fluorine may be used.

Thereafter, the cylindrical metal mold coated with the polyimide precursor composition is dried by being heated or being placed in a vacuum environment so as to volatilize 30% by weight or more, preferably 50% by weight or more of the solvent contained.

Subsequently, the dried film is subjected to imidization treatment, and as a result, a polyimide resin layer is formed.

In the imidization treatment, heating is performed under the condition of, for example, 150° C. to 400° C. (preferably from 200° C. to 300° C.) for 20 minutes to 60 minutes. In this manner, an imidization reaction occurs, and the polyimide resin layer is formed. During the heating reaction, heating is preferably performed by raising the temperature stepwise or slowly at a constant rate, before it reaches a final heating temperature. The temperature of imidization varies with, for example, the type of the tetracarboxylic dianhydride and diamine used as raw materials. If the degree of imidization is insufficient, the mechanical properties and electrical characteristics deteriorate. Therefore, the temperature is set such that the imidization is completed.

Thereafter, the cylindrical film formed on the surface of the cylindrical metal mold is detached to obtain an endless belt.

When the polyimide-molded article according to the present exemplary embodiment is used as an intermediate transfer belt, a surface resistivity of the outer circumferential surface thereof is preferably from 8 (Log Ω/square) to 13 (Log Ω/square) and more preferably from 8 (Log Ω/square) to 12 (Log Ω/square), in terms of the value of common logarithm. If the value of common logarithm of the surface resistivity exceeds 13 (Log Ω/square), a recording medium is electrostatically adsorbed onto the intermediate transfer member during secondary transfer, which makes it difficult to peel off the recording medium in some cases. On the other hand, if the value of common logarithm of the surface resistivity is less than 8 (Log Ω/square), a toner image primary-transferred to the intermediate transfer member is held with an insufficient force, which causes granularity in image quality or image disarray in some cases.

The value of common logarithm of the surface resistivity is controlled by the types of conductive materials and the amount of the conductive material added.

Polyimide-Molded Article

The polyimide-molded article formed of the polyimide precursor composition according to the present exemplary embodiment contains an aqueous solvent contained in the polyimide precursor composition according to the present exemplary embodiment and an aliphatic cyclic amine compound contained in the polyimide precursor composition according to the present exemplary embodiment.

The amount of the aqueous solvent contained in the polyimide-molded article formed of the polyimide precursor composition according to the present exemplary embodiment is 1 ppb or more and less than 1% in the polyimide-molded article. The amount of the aqueous solvent contained in the polyimide-molded article is determined by heating the polyimide-molded article and performing gas chromatography on the content of gas generated. Likewise, the amount of the aliphatic cyclic amine compound contained in the polyimide-molded article is also determined by heating the polyimide-molded article and performing gas chromatography on the content of gas generated.

Hereinafter, examples will be described, but the present invention is not limited to these examples. Moreover, unless otherwise specified, both the “part(s)” and “%” are based on weight.

### Example 1

### Preparation of Polyimide Precursor Composition (A-1)

900 g of water is filled in a flask equipped with a stirring rod, a thermometer, and a dropping funnel. 27.28 g (252.27 mmol) of p-phenylenediamine (hereinafter, described as PDA: a molecular weight of 108.14) and 51.03 g (504.54 mmol) of methyl morpholine (hereinafter, described as MMO: an aliphatic cyclic amine compound) are added thereto, and the mixture is dispersed by being stirred for 10 minutes at 20° C. 72.72 g (247.16 mmol) of 3,3′,4,4′-biphenyltetracarboxylic dianhydride (hereinafter, described as RPDA: a molecular weight of 294.22) is added to the solution. While the reaction temperature is being kept at 20° C., the resultant is dissolved and reacted by being stirred for 24 hours, thereby obtaining a polyimide precursor composition (A-1).

The imidization rate of the formed polyimide precursor is 0.02. As a result of measuring the amount of terminal amino groups as described above, the polyimide precursor is confirmed to contain an amino group at least on the terminal thereof.

The respective measurements are performed as below.

Method of Viscosity Measurement

The viscosity is measured using an E-type viscometer under the following conditions.

Measurement instrument: E-type rotating viscometer TV-20H (TOKI SANGYO CO., LTD.)

Measurement probe: No. 3-type rotor 3° xR14

Measurement temperature: 22° C.

Method of Solid Content Measurement

The solid content is measured using a Thermo Gravimetry/Differential Thermal Analyzer under the following conditions. The value measured at 380° C. is used, and the solid content is measured as a proportion of the solid content as polyimide.

Measurement instrument: Thermo Gravimetry/Differential Thermal Analyzer TG/DTA 6200(Seiko Instruments Inc.)

Measurement range: 20° C. to 400° C.

Rate of temperature increase: 20° C./min

Evaluation

The obtained polyimide precursor composition (A-1) is used to prepare a film, and the film forming property is evaluated. Moreover, dynamic properties (tensile strength and tensile elongation) of the prepared film are measured.

Film Forming Property

The polyimide precursor composition (A-1) is used to prepare a film by the following operation. The prepared film is evaluated in terms of (1) void marks and (2) surface unevenness/pattern.

Coating method: bar coating method using a coating blade equipped with a spacer to yield a coating thickness of 100 μm

Coating substrate: 1.1 mm t glass plate

Drying temperature and Drying time: 60° C.×10 minutes

Baking temperature and Baking time: 250° C.×30 minutes

(1) Void Marks

The prepared film is evaluated to confirm whether there are void marks on the surface of the film. The evaluation criteria are as follows.

A: No void marks are found.

B: It is possible to confirm 1 or more and less than 10 void marks on the surface of the prepared film.

C: There are 10 or more and less than 50 void marks scattered on the surface of the prepared film.

D: Numerous void marks are evenly caused on the surface of the prepared film.

(2) Surface Unevenness/Pattern

The prepared film is evaluated to confirm whether surface unevenness and patterns are caused on the surface of the prepared film. The evaluation criteria are as follows.

A: Surface unevenness and patterns are not found.

B: It is possible to confirm surface unevenness and patterns to a slight extent in a portion of the surface of the prepared film (less than 10% of the surface area of the prepared film).

C: It is possible to confirm surface unevenness and patterns in a portion of the surface of the prepared film.

D: Surface unevenness and patterns are evenly caused on the surface of the prepared film (10% or more of the surface area of the prepared film).

Tensile Strength/Elongation

From the prepared film, a piece of sample is molded by punching by using a No. 3 dumbbell. The piece of sample is installed in a tensile tester, and under the following conditions, an applied load (tensile strength) at which the sample undergoes tensile breaking and elongation at break (tensile elongation) are measured.

Measurement instrument: A tensile tester 1605 model manufactured by AIKOH ENGINEERING CO., LTD.

Sample length: 30 mm

Sample width: 5 mm

Tensile rate: 10 mm/min

### Examples 2 to 19

### Preparation of Polyimide Precursor Compositions (A-2) to (A-19)

Polyimide precursor compositions (A-2) to (A-19) are prepared in the same manner as in Example 1, except that synthesis conditions of the polyimide precursor composition are changed to the conditions described in the following Tables 1 and 2.

Moreover, films are prepared and evaluated in the same manner as in Example 1. The evaluation results are shown in Tables 1 and 2.

### Comparative Example 1

### Preparation of Polyimide Precursor Composition (X-1)

900 g of N-methyl-2-pyrrolidone (hereinafter, described as NMP) is filled in a flask equipped with a stirring rod, a thermometer, and a dropping funnel, and 27.28 g (252.27 mmol) of PDA (a molecular weight of 108.14) is added thereto under a dried nitrogen gas flow. The mixture is stirred while the solution temperature is being kept at 30° C., and 72.72 g (247.16 mmol) of BPDA (a molecular weight of 294.22) is slowly added thereto. The dissolution of the diamine compound and tetracarboxylic dianhydride is confirmed, and then the resultant is further reacted for 24 hours while the reaction temperature is being kept at 30° C. The viscosity of the polyimide precursor solution (a solid content of 10% by weight) that is measured by the method described above is 50 Pa.s.

The obtained polyimide precursor solution is named a polyimide precursor composition (X-1).

The obtained polyimide precursor composition (X-1) is used to prepare a film in the same manner as in Example 1, and the film is evaluated. The evaluation results are shown in Table 3.

As a result, when the baking temperature thereof is set to 250° C. as in Example 1, NMP remains in the film. Accordingly, the degree of both the tensile strength and tensile elongation is lowered compared to Example 1. As one of the reason, it is considered that NMP with a high boiling point contained in the polyimide precursor composition (X-1) remains in the prepared film, whereby the mechanical strength is reduced.

### Comparative Example 2

### Preparation of Polyimide Precursor Composition (X-2)

The polyimide precursor composition (X-1) prepared in Comparative example 1 is added to acetone having a volume 10 times greater than that of the composition, thereby reprecipitating the polyimide precursor. The polyimide precursor is filtered and then dried for 24 hours at 40° C. under a reduced pressure (10 mmHg). After drying, 90 g of water and 4.43 g (49.71 mmol) of dimethylaminoethanol (hereinafter, described as DMAEt: a molecular weight of 89.14) are added to 10 g of the polyimide precursor (49.71 mmol equivalent of a carboxyl group), and the mixture is dissolved under stirring for 6 hours at 25° C., thereby obtaining a polyimide precursor composition (X-2).

The obtained polyimide precursor composition (X-2) is used to prepare a film in the same manner as in Example 1, and the film is evaluated. The results are shown in Table 3.

As a result, it is confirmed that the film forming property thereof is excellent just like Example 1. As a result of a tensile test, it is found that a degree of both the tensile strength and tensile elongation thereof is low compared to Example 1.

The content of NMP remaining in the polyimide precursor composition (X-2) is analyzed by liquid chromatography. As a result, the content is confirmed to be 6% by weight in the solvent. It is considered that NMP remains in the formed film as in Comparative example 1, whereby the tensile properties of the film sample prepared using the polyimide precursor composition (X-2) becomes poor.

### Comparative Example 3

### Preparation of Polyimide Precursor Composition (X-3)

An organic amine compound is added during the polymerization of Comparative example 1 to perform polymerization in the following manner.

900 g of NMP is filled in a flask equipped with a stirring rod, a thermometer, and a dropping funnel, and 27.28 g (252.27 mmol) of PDA and 44.97 g (504.54 mmol) of DMAEt are added thereto under a dried nitrogen gas flow. While the solution temperature is being kept at 30° C., 72.72 g (247.16 mmol) of BPDA is slowly added thereto under stirring. The dissolution of the diamine compound and tetracarboxylic dianhydride is confirmed, and then the resultant is further reacted for 24 hours while the reaction temperature is being kept at 30° C. The viscosity of the polyimide precursor solution (a solid content of 20% by weight) that is measured by the above method is 5 Pa.s.

The obtained polyimide precursor solution is named a polyimide precursor composition (X-3).

The obtained polyimide precursor composition (X-3) is used to prepare a film in the same manner as in Example 1, and the film is evaluated. The evaluation results are shown in Table 3.

### Comparative Example 4

### Preparation of Polyimide Precursor Composition (X-4)

450 g of water is filled in a flask equipped with a stirring rod, a thermometer, and s dropping funnel. 13.44 g (124 mmol) of p-phenylenediamine (PDA) and 29.87 g (310.73 mmol) of 1,2-dimethylimidazole (1,2-DMZ: a molecular weight of 96.13) are added thereto and dissolved under stirring for 1 hour at 25° C. 36.56 g (124 mmol) of 3,3′,4,4′-biphenyltetracarboxylic dianhydride (BPDA) is added to the solution. The dissolution of the diamine compound and tetracarboxylic dianhydride is confirmed, and then the resultant is reacted under stirring for 12 hours while the reaction temperature is being kept at 25° C., thereby obtaining a polyimide precursor composition (X-4).

The imidization rate of the formed polyimide precursor is 0.05. The amount of terminal amino groups is measured as described above, and as a result, an amino group derived from an aromatic diamine compound is practically not detected.

The obtained polyimide precursor composition (X-4) is used to prepare a film in the same manner as in Example 1, and the film is evaluated. The evaluation results are shown in Table 3.

### Comparative Example 5

### Preparation of Polyimide Precursor Composition (X-5)

Polymerization is performed in the same manner as in Example 1, except that the amine compound added to the polyimide precursor composition (A-1) is changed from methyl morpholine (MMO/aliphatic cyclic amine, 504.54 mmol) used in Example 1 to triethanolamine (hereinafter, described as TEA: aliphatic chain-like amine, 504.54 mmol). However, the monomer does not dissolve, polymerization fails to be performed.

TABLE 1

| | | | Example 1 | Example 2 | Example 3 | Example 4 | Example 5 | Example 6 |
|---|---|---|---|---|---|---|---|---|
| | Polyimide precursor composition | | A-1 | A-2 | A-3 | A-4 | A-5 | A-6 |
| Synthesis | Tetracarboxylic | Chemical species | BPDA | BPDA | BPDA | BPDA | BPDA | BPDA |
| conditions | dianhydride | g | 72.72 | 70.83 | 71.93 | 72.34 | 72.65 | 72.75 |
| | | mmol | 247.16 | 240.75 | 244.47 | 245.88 | 246.91 | 247.25 |
| | Diamine compound | Chemical species | PDA | PDA | PDA | PDA | PDA | PDA |
| | | g | 27.28 | 28.93 | 27.83 | 27.41 | 27.11 | 27.01 |
| | | mmol | 252.27 | 267.50 | 257.33 | 253.48 | 250.67 | 249.75 |
| | Tetracarboxylic dianhydride/diamine | | 0.98 | 0.90 | 0.95 | 0.97 | 0.985 | 0.99 |
| | compound (molar ratio) | | | | | | | |
| | Amine compound | Chemical species | MMO | MMO | MMO | MMO | MMO | MMO |
| | | g | 51.03 | 54.11 | 52.06 | 51.28 | 50.71 | 50.52 |
| | | mmol | 504.54 | 534.99 | 514.67 | 506.97 | 501.34 | 499.49 |
| | Treatment rate | Mol % | 100 | 100 | 100 | 100 | 100 | 100 |
| | Aqueous solvent | Chemical species | Water | Water | Water | Water | Water | Water |
| | | g | 900 | 900 | 900 | 900 | 900 | 900 |
| | Solid content of | % | 10 | 10 | 10 | 10 | 10 | 10 |
| | polyimide precursor | | | | | | | |
| | State of liquid | | Homo- | Homo- | Homo- | Homo- | Homo- | Homo- |
| | | | geneously | geneously | geneously | geneously | geneously | geneously |
| | | | dissolved | dissolved | dissolved | dissolved | dissolved | dissolved |
| | Imidization rate | | 0.02 | 0.02 | 0.02 | 0.02 | 0.02 | 0.02 |
| | Molecular weight | Mn | 20,000 | 1,000 | 5,000 | 10,000 | 30,000 | 500,000 |
| | Solid content | % | 9.1 | 9.1 | 9.1 | 9.1 | 9.1 | 9.1 |
| | Viscosity | Pa · s | 50 | 5 | 20 | 30 | 60 | 80 |
| | Terminal amino group | | Contained | Contained | Contained | Contained | Contained | Contained |
| Film forming | Void marks | | A | A | A | A | A | A |
| property | Surface unevenness/pattern | | A | A | A | A | A | A |
| Dynamic | Tensile strength | Mpa | 300 | 280 | 290 | 300 | 300 | 310 |
| properties | Tensile elongation | % | 40 | 30 | 35 | 40 | 40 | 45 |

| | | | Example 7 | Example 8 | Example 9 | Example 10 |
|---|---|---|---|---|---|---|
| | Polyimide precursor composition | | A-7 | A-8 | A-9 | A-10 |
| Synthesis | Tetracarboxylic | Chemical species | BPDA | BPDA | PMDA | BTDA |
| conditions | dianhydride | g | 72.84 | 58.90 | 51.52 | 74.32 |
| | | mmol | 247.58 | 200.24 | 236.21 | 233.70 |
| | Diamine compound | Chemical species | PDA | ODA | ODA | PDA |
| | | g | 26.91 | 40.90 | 48.24 | 25.45 |
| | | mmol | 248.83 | 204.27 | 240.92 | 235.35 |
| | Tetracarboxylic dianhydride/diamine | | 0.995 | 0.98 | 0.98 | 0.95 |
| | compound (molar ratio) | | | | | |
| | Amine compound | Chemical species | MMO | MMO | MMO | MMO |
| | | g | 50.34 | 41.32 | 48.74 | 47.61 |
| | | mmol | 497.66 | 408.53 | 481.84 | 470.69 |
| | Treatment rate | Mol % | 100 | 100 | 100 | 100 |
| | Aqueous solvent | Chemical species | Water | Water | Water | Water |
| | | g | 900 | 900 | 900 | 900 |
| | Solid content of | % | 10 | 10 | 10 | 10 |
| | polyimide precursor | | | | | |
| | State of liquid | | Homo- | Homo- | Homo- | Homo- |
| | | | geneously | geneously | geneously | geneously |
| | | | dissolved | dissolved | dissolved | dissolved |
| | Imidization rate | | 0.02 | 0.02 | 0.02 | 0.02 |
| | Molecular weight | Mn | 100,000 | 20,000 | 20,000 | 20,000 |
| | Solid content | % | 9.1 | 9.1 | 9.3 | 9.2 |
| | Viscosity | Pa · s | 120 | 40 | 40 | 30 |
| | Terminal amino group | | Contained | Contained | Contained | Contained |
| Film forming | Void marks | | A | A | A | A |
| property | Surface unevenness/pattern | | A | A | A | A |
| Dynamic | Tensile strength | Mpa | 310 | 250 | 200 | 200 |
| properties | Tensile elongation | % | 45 | 35 | 30 | 20 |

TABLE 2

| | | | Example 11 | Example 12 | Example 13 | Example 14 | Example 15 |
|---|---|---|---|---|---|---|---|
| | Polyimide precursor composition | | A-11 | A-12 | A-13 | A-14 | A-15 |
| Synthesis | Tetracarboxylic | Chemical species | BPDA | BPDA | BPDA | BPDA | BPDA |
| conditions | dianhydride | g | 72.72 | 72.72 | 72.72 | 72.72 | 72.72 |
| | | mmol | 247.16 | 247.16 | 247.16 | 247.16 | 247.16 |
| | Diamine compound | Chemical species | PDA | PDA | PDA | PDA | PDA |
| | | g | 27.28 | 27.28 | 27.28 | 27.28 | 27.28 |
| | | mmol | 252.27 | 252.27 | 252.27 | 252.27 | 252.27 |
| | Tetracarboxylic dianhydride/diamine | | 0.98 | 0.98 | 0.98 | 0.98 | 0.98 |
| | compound (molar ratio) | | | | | | |
| | Amine compound | Chemical species | MMO | MMO | MMO | MMO | MMO |
| | | g | 101.80 | 152.70 | 25.45 | 40.72 | 203.60 |
| | | mmol | 1006.40 | 1509.60 | 251.60 | 402.56 | 2012.80 |
| | Treatment rate | Mol % | 200 | 300 | 50 | 80 | 400 |
| | Aqueous solvent | Chemical species | Water | Water | Water | Water | Water |
| | | g | 900 | 900 | 900 | 900 | 900 |
| | Solid content of | % | 10 | 10 | 10 | 10 | 10 |
| | polyimide precursor | | | | | | |
| | State of liquid | | Homo- | Homo- | Homo- | Homo- | Homo- |
| | | | geneously | geneously | geneously | geneously | geneously |
| | | | dissolved | dissolved | dissolved | dissolved | dissolved |
| | Imidization rate | | 0.02 | 0.02 | 0.02 | 0.02 | 0.02 |
| | Molecular weight | Mn | 20,000 | 20,000 | 20,000 | 20,000 | 20,000 |
| | Solid content | % | 9.1 | 9.1 | 9.1 | 9.1 | 9.1 |
| | Viscosity | Pa · s | 60 | 70 | 120 | 100 | 20 |
| | Terminal amino group | | Contained | Contained | Contained | Contained | Contained |
| Film forming | Void marks | | A | A | A | A | A |
| property | Surface unevenness/pattern | | A | A | A | A | A |
| Dynamic | Tensile strength | Mpa | 300 | 300 | 300 | 280 | 280 |
| properties | Tensile elongation | % | 40 | 40 | 40 | 35 | 35 |

| | | | Example 16 | Example 17 | Example 18 | Example 19 |
|---|---|---|---|---|---|---|
| | Polyimide precursor composition | | A-16 | A-17 | A-18 | A-19 |
| Synthesis | Tetracarboxylic | Chemical species | BPDA | BPDA | BPDA | PMDA |
| conditions | dianhydride | g | 72.72 | 72.72 | 72.72 | 51.52 |
| | | mmol | 247.16 | 247.16 | 247.16 | 236.21 |
| | Diamine compound | Chemical species | PDA | PDA | PDA | ODA |
| | | g | 27.28 | 27.28 | 27.28 | 48.24 |
| | | mmol | 252.27 | 252.27 | 252.27 | 240.92 |
| | Tetracarboxylic dianhydride/diamine | | 0.98 | 0.98 | 0.98 | 0.98 |
| | compound (molar ratio) | | | | | |
| | Amine compound | Chemical species | MMO | 1- | N,N- | pyrrolidine |
| | | | | methylpiperidine | dimethylpiperazine | |
| | | g | 254.49 | 50.04 | 57.61 | 35.88 |
| | | mmol | 2516.00 | 504.54 | 504.54 | 504.54 |
| | Treatment rate | Mol % | 500 | 100 | 100 | 100 |
| | Aqueous solvent | Chemical species | Water | Water | Water | Water |
| | | g | 900 | 900 | 900 | 900 |
| | Solid content of | % | 10 | 10 | 10 | 10 |
| | polyimide precursor | | | | | |
| | State of liquid | | Homo- | Homo-geneously | Homo-geneously | Homo- |
| | | | geneously | dissolved | dissolved | geneously |
| | | | dissolved | | | dissolved |
| | Imidization rate | | 0.02 | 0.05 | 0.05 | 0.06 |
| | Molecular weight | Mn | 20,000 | 100,000 | 20,000 | 20,000 |
| | Solid content | % | 9.1 | 9.1 | 9.1 | 9.3 |
| | Viscosity | Pa · s | 10 | 40 | 40 | 20 |
| | Terminal amino group | | Contained | Contained | Contained | Contained |
| Film forming | Void marks | | A | A | A | A |
| property | Surface unevenness/pattern | | A | A | A | A |
| Dynamic | Tensile strength | Mpa | 260 | 300 | 300 | 280 |
| properties | Tensile elongation | % | 35 | 40 | 40 | 35 |

TABLE 3

| | | | Comparative | Comparative | Comparative | Comparative | Comparative |
|---|---|---|---|---|---|---|---|
| | | | example 1 | example 2 | example 3 | example 4 | example 5 |
| | Polyimide precursor composition | | X-1 | X-2 | X-3 | X-4 | X-5 |
| Synthesis | Tetracarboxylic | Chemical species | BPDA | → | BPDA | BPDA | BPDA |
| conditions | dianhydride | g | 72.72 | → | 72.72 | 36.56 | 7 2.72 |
| | | mmol | 247.16 | → | 247.16 | 124 | 247.16 |
| | Diamine compound | Chemical species | PDA | → | PDA | PDA | PDA |
| | | g | 27.28 | → | 27.28 | 13.44 | 27.28 |
| | | mmol | 252.27 | → | 252.27 | 124 | 252.27 |
| | Tetracarboxylic dianhydride/diamine | | 0.98 | → | 0.98 | 1 | 0.98 |
| | compound (molar ratio) | | | | | | |
| | Amine compound | Chemical species | — | → | DMAEt | 1,2-DMZ | TEA |
| | | g | — | → | 44.97 | 29.87 | 50.96 |
| | | mmol | — | → | 504.54 | 310.73 | 504.54 |
| | Treatment rate | Mol % | — | → | 100 | 125 | 100 |
| | Solvent | Chemical species | NMP | → | NMP | Water | Water |
| | | g | 900 | → | 900 | 450 | 900 |
| | Solid content of | % | 10 | 10 | 10 | 10 | 10 |
| | polyimide precursor | | | | | | |
| | State of liquid | | Homogeneously | Homogeneously | Homogeneously | Homogeneously | Undissolved |
| | | | | dissolved | dissolved | dissolved | dissolved |
| | | | | (solvent replacement) | | | |
| | Imidization rate | | 0.02 | 0.02 | 0.02 | 0.05 | — |
| | Molecular weight | Mn | 20,000 | → | 1,000 | 15,000 | — |
| | Solid content | % | 9.1 | → | 20 | 9 | — |
| | Viscosity | Pa · s | 50 | 60 | 5 | 16.3 | — |
| | Terminal amino group | | Contained | Contained | Contained | Not detected | — |
| Film forming | Void marks | | A | A | B | D | — |
| property | Surface unevenness/pattern | | A | A | B | D | — |
| Dynamic | Tensile strength | Mpa | 100 | 90 | 50 | 100 | — |
| properties | Tensile elongation | % | 10 | 10 | 10 | 10 | — |

From the above results, it is understood that the evaluation results of the film forming property and dynamic properties obtained from the present examples are better than those obtained from comparative examples.

The respective abbreviations in Tables 1 to 3 are as follows. Moreover, “-” in Tables 1 to 3 indicates that the component is not added or measured, and “→” indicates that the cell includes the same data as that of column to the left.

Tetracarboxylic acid: “BPDA” (3,3′,4,4′-biphenyltetracarboxylic dianhydride), “PMDA” (pyromellitic dianhydride), “BTDA” (3,4,3′,4′-tetracarboxylic dianhydride)

Diamine compound: “PDA” (p-phenylenediamine), “ODA” (4,4′-diaminodiphenylether)

Amine compound: MMO (methylmorpholine), DMAEt (dimethylaminoethanol), 1-methylpiperidine (a molecular weight Mw of 99.17), N,N-dimethylpiperazine (a molecular weight Mw of 114.19), pyrrolidine (a molecular weight Mw of 71.12), 1,2-DMZ (1,2-dimethylimidazole), TEA (triethanolamine)

Solvent: NMP(N-methyl-2-pyrrolidone)

In the present exemplary embodiment, the “treatment rate” is the amount (mol %) of an organic amine compound based on the theoretical amount of a carboxyl group contained in the polyimide precursor. The theoretical amount of a carboxyl group refers to a value obtained by doubling the molar amount of tetracarboxylic acid contained in the polyimide precursor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor composition comprising:
a resin that contains a repeating unit represented by the following Formula (I) and has an imidization rate of 0.2 or less, 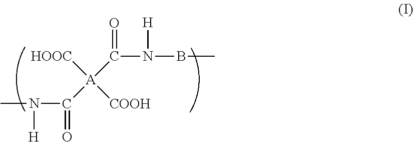
wherein A represents a tetravalent organic group, and B represents a divalent organic group;
an aliphatic cyclic amine compound; and
an aqueous solvent,
wherein the resin and the aliphatic cyclic amine compound are dissolved in the aqueous solvent.

2. The polyimide precursor composition according to claim 1,
wherein the aliphatic cyclic amine compound is at least one kind of compound selected from morpholines, piperidines, piperazines, pyrrolidines, and pyrazolidines.

3. The polyimide precursor composition according to claim 1,
wherein the aliphatic cyclic amine compound is at least one kind of compound selected from morpholines.

4. The polyimide precursor composition according to claim 1,
wherein the aliphatic cyclic amine compound is a tertiary amine compound.

5. The polyimide precursor composition according to claim 1,
wherein a content of the aliphatic cyclic amine compound is from 50 mol % to 500 mol % based on a carboxyl group contained in the resin.

6. The polyimide precursor composition according to claim 1,
wherein a content of the aliphatic cyclic amine compound is from 80 mol % to 400 mol % based on a carboxyl group contained in the resin.

7. The polyimide precursor composition according to claim 1,
wherein a content of the aliphatic cyclic amine compound is from 100 mol % to 300 mol % based on a carboxyl group contained in the resin.

8. The polyimide precursor composition according to claim 1,
wherein the resin is synthesized from an aromatic tetracarboxylic dianhydride and an aromatic diamine compound.

9. The polyimide precursor composition according to claim 1,
wherein the resin is synthesized from at least one kind of aromatic tetracarboxylic dianhydride which is selected from a pyromellitic dianhydride, a biphenyltetracarboxylic dianhydride, and a benzophenone tetracarboxylic dianhydride and at least one kind of aromatic diamine compound which is selected from phenylenediamine and diaminodiphenylether.

10. The polyimide precursor composition according to claim 1,
wherein the resin includes a resin having an amino group on the terminal thereof.

11. The polyimide precursor composition according to claim 1,
wherein a number average molecular weight of the resin is from 1,000 to 100,000.

12. The polyimide precursor composition according to claim 1,
wherein the resin has an imidization rate of 0.15 or less.

13. The polyimide precursor composition according to claim 1,
wherein the resin has an imidization rate of 0.10 or less.

14. A method for producing a polyimide precursor composition, comprising:
forming a resin by polymerizing a tetracarboxylic dianhydride and a diamine compound in an aqueous solvent in the presence of an aliphatic cyclic amine compound.
